(19) United States
(12) Patent Application Publication
(10) Pub. No.: US 2014/0015752 A1
(43) Pub. Date: Jan. 16, 2014

(54) POWER-SAVING METHOD FOR WHEEL MOUSE

(71) Applicant: PRIMAX ELECTRONICS LTD., Taipei (TW)

(72) Inventors: Chien-Nan Lin, Neihu, Taipei (TW); Tsung-Wen Hsueh, Neihu, Taipei (TW); Chun-Nan Su, Neihu, Taipei (TW)

(73) Assignee: PRIMAX ELECTRONICS LTD., Taipei (TW)

(21) Appl. No.: 13/672,836

(22) Filed: Nov. 9, 2012

(30) Foreign Application Priority Data
Jul. 13, 2012 (TW) 101125395

(51) Int. Cl. G06F 3/033

(52) U.S. Cl. CPC G06F 3/033
USPC 345/166

(57) ABSTRACT

A power-saving method for a wheel mouse is provided. The power-saving method is used to control the illumination cycle of a light emitter by judging whether a scroll wheel is triggered or judging whether the output signal from the light receiver is changed. In a case that the illumination cycle of the light emitter is a shorter second cycle, the light emitter can quickly generate the optical signal. Consequently, the optical signal is not lost, and the possibility of erroneously operating the wheel mouse is eliminated. Whereas, in a case that the illumination cycle of the light emitter is a longer first cycle, the controlling unit can reduce the power consumption in order to achieve the power-saving efficacy.

### FIELD OF THE INVENTION

The present invention relates to a power-saving method for a wheel mouse, and more particularly to a power-saving method for a wheel mouse by controlling the operations of a light emitter of a scroll wheel within the wheel mouse.

### BACKGROUND OF THE INVENTION

A mouse, a keyboard and a touchpad are widely-used input devices of a computer system. Among these input devices, the mouse is the most prevailing because it is very easy-to-use. When a mouse is held on the palm of a user's hand, the mouse may be intuitively operated to control movement of the cursor shown on the display screen of the computer system.

Hereinafter, the structures and the functions of a conventional mouse will be illustrated with reference to a wheel mouse as shown in FIGS. 1 and 2. FIG. 1 schematically illustrates the communication between a conventional wheel mouse and a computer system. FIG. 2 is a schematic partial exploded view illustrating a portion of the conventional wheel mouse. The computer system 2 comprises a computer host 21 and a display screen 22. The computer host 21 is in communication with the wheel mouse 1 and the display screen 22. The computer host 21 has a connecting port 211. A graphic-based window 221 and a cursor 222 are displayed on the display screen 22. The wheel mouse 1 is used for controlling the cursor 222 to have the computer host 21 execute a corresponding command. The wheel mouse 1 comprises a casing 10, a left button 11, a right button 12, a scroll wheel 13, a light emitter 14, a light receiver 15, an optical displacement sensing module (not shown), a wireless signal transmitter 16, and a wireless signal receiver 17. The casing 10 is used for supporting a user's palm. When the casing 10 is moved by the user, the optical displacement sensing module at the bottom of the casing 10 generates a displacement signal according to the displacement amount of the casing 10. According to the displacement signal, the movement of the cursor 222 is correspondingly controlled. By clicking the left button 11 or the right button 12, a corresponding button signal is issued to the computer host 21. According to the button signal, the computer host 21 executes a corresponding command. The scroll wheel 13 is arranged between the left button 11 and the right button 12. By rotating the scroll wheel 13, a corresponding scrolling signal is generated. According to the scrolling signal, the graphic-based window 221 shown on the display screen 22 may be scrolled upwardly or downwardly by the computer host 21. The wireless signal transmitter 16 is disposed within the casing 10 for transmitting the displacement signal, the button signal and the scrolling signal. The wireless signal receiver 17 is inserted into the connecting port 211. The wireless signal receiver 17 is in communication with the computer host 21 for receiving the displacement signal, the button signal and the scrolling signal from the wireless signal transmitter 16 and transmitting these signals to the computer host 21.

In FIG. 2, the scroll wheel 13 and the light emitter 14 are shown. The scroll wheel 13 has a grating structure 131. The grating structure 131 is disposed within the scroll wheel 13. The grating structure 131 comprises plural elongated elements 1311. The light emitter 14 is located at a side of the scroll wheel 13 for generating an optical signal. The optical signal is projected to the scroll wheel 13. For example, the light emitter 14 is an infrared light emitter, and the optical signal is an infrared optical signal. The light receiver 15 is located at another side of the scroll wheel 13 for receiving the optical signal that passes through the gaps between the plural elongated elements 1311. During the scroll wheel 13 is rotated, the grating structure 131 is moved in response to the rotation of the scroll wheel 13. Consequently, at a first time spot, the optical signal from the light emitter 14 is passed through one of the gaps between plural elongated elements 1311 and received by the light receiver 15. At a second time spot after the first time spot, the optical signal is sheltered by the plural elongated elements 1311 and thus fails to be received by the light receiver 15. According to the optical signal which is discontinuously received by the light receiver 15, the conventional wheel mouse 1 generates a scrolling signal. Through the wireless signal transmitter 16 and the wireless signal receiver 17, the scrolling signal is transmitted to the computer host 21. According to the scrolling signal, the graphic-based window 221 is correspondingly scrolled by the computer host 21. The structures and the operating principles of the conventional wheel mouse 1 have been illustrated above.

Moreover, during the process of operating the scroll wheel 13, regardless of whether the scroll wheel 13 is rotated by the user to be triggered, the light emitter 14 continuously generates the optical signal. Since the optical signal is continuously generated, the power consumption of the conventional wheel mouse 1 is increased. The light emitter 14 has to continuously generate the optical signal because the scroll wheel 13 is possibly rotated by the user at any time. In views of the power-saving purpose, the light emitter 14 may be temporarily turned off. However, if the scroll wheel 13 is rotated by the user when the light emitter 14 is turned off, the light emitter 14 fails to generate the optical signal in response to the rotation of the scroll wheel 13. Under this circumstance, the conventional wheel mouse 1 is erroneously operated.

Therefore, there is a need of provide a power-saving method for a wheel mouse in order to reduce power consumption and avoid the generation of the erroneous operation.

### SUMMARY OF THE INVENTION

The present invention provides a power-saving method for a wheel mouse in order to reduce power consumption and avoid the generation of the erroneous operation.

In accordance with an aspect of the present invention, there is provided a power-saving method for a wheel mouse. The wheel mouse includes a scroll wheel, a light emitter and a light receiver. The scroll wheel is rotated to be triggered. The light emitter generates an optical signal. The optical signal passing through the scroll wheel is received by the light receiver. The light receiver outputs an output signal according to the optical signal. The power-saving method includes the steps of presetting an illumination cycle of the light emitter as a first cycle and judging whether the output signal from the light receiver is changed is performed. If the output signal from the light receiver is judged to be in a changed status, the illumination cycle of the light emitter is changed to a second cycle, wherein the second cycle is shorter than the first cycle. If the output signal from the light receiver is switched from the changed status to an unchanged status, a step of judging whether a time period of maintaining the unchanged status of the output signal from the light receiver reaches a predetermined time period is performed. If the time period of maintaining the unchanged status of the output signal from the light receiver reaches the predetermined time period, the illumination cycle of the light emitter is changed to the first cycle. If the time period of maintaining the unchanged status of the output signal from the light receiver does not reach the predetermined time period, the step of judging whether the output signal from the light receiver is changed is performed again.

In an embodiment, if the illumination cycle of the light emitter is equal to the first cycle and the output signal from the light receiver is judged to be in the unchanged status, the power-saving method further includes a step of starting to calculate the time period of maintaining the unchanged status of the output signal from the light receiver.

In an embodiment, after the illumination cycle of the light emitter is controlled to be the first cycle, the power-saving method further includes a step of judging whether the time period of maintaining the unchanged status of the output signal from the light receiver reaches an additional predetermined time period. If the time period of maintaining the unchanged status of the output signal from the light receiver reaches the additional predetermined time period, the light emitter and the light receiver are turned off. If the time period of maintaining the unchanged status of the output signal from the light receiver does not reach the additional predetermined time period, the step of judging whether the output signal from the light receiver is changed is performed again

In an embodiment, the predetermined time period is shorter than the additional predetermined time period.

In an embodiment, if the time period of maintaining the unchanged status of the output signal from the light receiver does not reach the additional predetermined time period and if the output signal from the light receiver is judged to be in the unchanged status, the power-saving method further includes a step of continuing to calculate the time period of maintaining the unchanged status of the output signal from the light receiver. If the time period of maintaining the unchanged status of the output signal from the light receiver does not reach the additional predetermined time period and if the output signal from the light receiver is judged to be switched from the unchanged status to the changed status, the power-saving method further includes steps of changing the illumination cycle of the light emitter to the second cycle and zeroing the time period of maintaining the unchanged status of the output signal from the light receiver.

In an embodiment, after the time period of maintaining the unchanged status of the output signal from the light receiver is continued to be calculated, the power-saving method further includes a step of judging again whether the time period of maintaining the unchanged status of the output signal from the light receiver reaches the additional predetermined time period.

In an embodiment, if the time period of maintaining the unchanged status of the output signal from the light receiver does not reach the predetermined time period and if the output signal from the light receiver is judged to be in the unchanged status, the power-saving method further includes a step of continuing to calculate the time period of maintaining the unchanged status of the output signal from the light receiver. If the time period of maintaining the unchanged status of the output signal from the light receiver does not reach the predetermined time period and if the output signal from the light receiver is judged to be switched from the unchanged status to the changed status, the power-saving method further includes steps of changing the illumination cycle of the light emitter to the second cycle and zeroing the time period of maintaining the unchanged status of the output signal from the light receiver.

In an embodiment, after the time period of maintaining the unchanged status of the output signal from the light receiver is continued to be calculated, the power-saving method further includes a step of judging again whether the time period of maintaining the unchanged status of the output signal from the light receiver reaches the predetermined time period.

In an embodiment, after the time period of maintaining the unchanged status of the output signal from the light receiver is zeroed, if the output signal from the light receiver is judged to be switched from the unchanged status to the changed status, the power-saving method further includes a step of judging again whether the time period of maintaining the unchanged status of the output signal from the light receiver reaches the predetermined time period.

In an embodiment, after the illumination cycle of the light emitter is changed to the second cycle, the power-saving method further includes steps of transmitting a scrolling signal of the wheel mouse to a computer system, and judging whether the scrolling signal has been completely transmitted to the computer system. If the scrolling signal has been not completely transmitted to the computer system, the scrolling signal is continuously transmitted to the computer system. If the scrolling signal has been completely transmitted to the computer system, the step of judging whether the output signal from the light receiver is changed is performed again.

In accordance with another aspect of the present invention, there is provided a power-saving method for a wheel mouse. The wheel mouse includes a scroll wheel, a light emitter and a light receiver. The scroll wheel is rotated to be triggered. The light emitter generates an optical signal. The optical signal passing through the scroll wheel is received by the light receiver. The light receiver outputs an output signal according to the optical signal. The power-saving method includes the steps of presetting an illumination cycle of the light emitter as a first cycle and judging whether the scroll wheel is triggered. If the scroll wheel is judged to be in a triggered status, the illumination cycle of the light emitter is changed to a second cycle, wherein the second cycle is shorter than the first cycle. If the scroll wheel is switched from the triggered status to an untriggered status, a step of judging whether a time period of maintaining the untriggered status of the scroll wheel reaches a predetermined time period is performed. If the time period of maintaining the untriggered status of the scroll wheel reaches the predetermined time period, the illumination cycle of the light emitter is changed to the first cycle. If the time period of maintaining the untriggered status of the scroll wheel does not reach the predetermined time period, the step of judging whether the scroll wheel is triggered is performed again.

In an embodiment, if the illumination cycle of the light emitter is equal to the first cycle and the scroll wheel is judged to be in the untriggered status, the power-saving method further includes a step of starting to calculate the time period of maintaining the untriggered status of the scroll wheel.

In an embodiment, after the illumination cycle of the light emitter is controlled to be the first cycle, the power-saving method further includes a step of judging whether the time period of maintaining the untriggered status of the scroll wheel reaches an additional predetermined time period. If the time period of maintaining the untriggered status of the scroll wheel reaches the additional predetermined time period, the light emitter and the light receiver are turned off. If the time period of maintaining the untriggered status of the scroll wheel does not reach the additional predetermined time period, the step of judging whether the scroll wheel is triggered is performed again.

In an embodiment, the predetermined time period is shorter than the additional predetermined time period.

In an embodiment, if the time period of maintaining the untriggered status of the scroll wheel does not reach the additional predetermined time period and if the scroll wheel is judged to be in the untriggered status, the power-saving method further includes a step of continuing to calculate the time period of maintaining the untriggered status of the scroll wheel. If the time period of maintaining the untriggered status of the scroll wheel does not reach the additional predetermined time period and if the scroll wheel is judged to be switched from the untriggered status to the triggered status, the power-saving method further includes steps of changing the illumination cycle of the light emitter to the second cycle and zeroing the time period of maintaining the untriggered status of the scroll wheel.

In an embodiment, after the time period of maintaining the untriggered status of the scroll wheel is continued to be calculated, the power-saving method further includes a step of judging again whether the time period of maintaining the untriggered status of the scroll wheel reaches the additional predetermined time period.

In an embodiment, if the time period of maintaining the untriggered status of the scroll wheel does not reach the predetermined time period and if the scroll wheel is judged to be in the untriggered status, the power-saving method further includes a step of continuing to calculate the time period of maintaining the untriggered status of the scroll wheel. If the time period of maintaining the untriggered status of the scroll wheel does not reach the predetermined time period and if the scroll wheel is judged to be switched from the untriggered status to the triggered status, the power-saving method further includes steps of changing the illumination cycle of the light emitter to the second cycle and zeroing the time period of maintaining the untriggered status of the scroll wheel.

In an embodiment, after the time period of maintaining the untriggered status of the scroll wheel is continued to be calculated, the power-saving method further includes a step of judging again whether the time period of maintaining the untriggered status of the scroll wheel reaches the predetermined time period.

In an embodiment, after the time period of maintaining the untriggered status of the scroll wheel is zeroed, if the scroll wheel is judged to be switched from the untriggered status to the triggered status, the power-saving method further includes a step of judging again whether the time period of maintaining the untriggered status of the scroll wheel reaches the predetermined time period.

In an embodiment, after the time period of maintaining the untriggered status of the scroll wheel is zeroed, the power-saving method further includes a step of judging whether a rotating degree of the scroll wheel reaches a rotating graduation. If the rotating degree of the scroll wheel does not reach the rotating graduation, the power-saving method further includes a step of judging whether the time period of maintaining the untriggered status of the scroll wheel reaches the predetermined time period.

In an embodiment, after the illumination cycle of the light emitter is changed to the second cycle, the power-saving method further includes steps of transmitting a scrolling signal of the wheel mouse to a computer system and judging whether the scrolling signal has been completely transmitted to the computer system. If the scrolling signal has been not completely transmitted to the computer system, the scrolling signal is continuously transmitted to the computer system. If the scrolling signal has been completely transmitted to the computer system, the step of judging whether the scroll wheel is triggered is performed again.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the communication between a conventional wheel mouse and a computer system;

FIG. 2 is a schematic partial exploded view illustrating a portion of the conventional wheel mouse;

FIG. 3 schematically illustrates the communication between a wheel mouse and a computer system according to an embodiment of the present invention;

FIG. 4 is a flowchart illustrating a power-saving method for a wheel mouse according to an embodiment of the present invention;

FIGS. 5A-5D schematically illustrate some conditions of generating the output signal by the light receiver of the wheel mouse of the present invention in response to the rotation of the scroll wheel; and

FIG. 6 is a flowchart illustrating a power-saving method for a wheel mouse according to another embodiment of the present invention.

### DETAILED DESCRIPTION OF THE PREFERRED EMBODIMENT

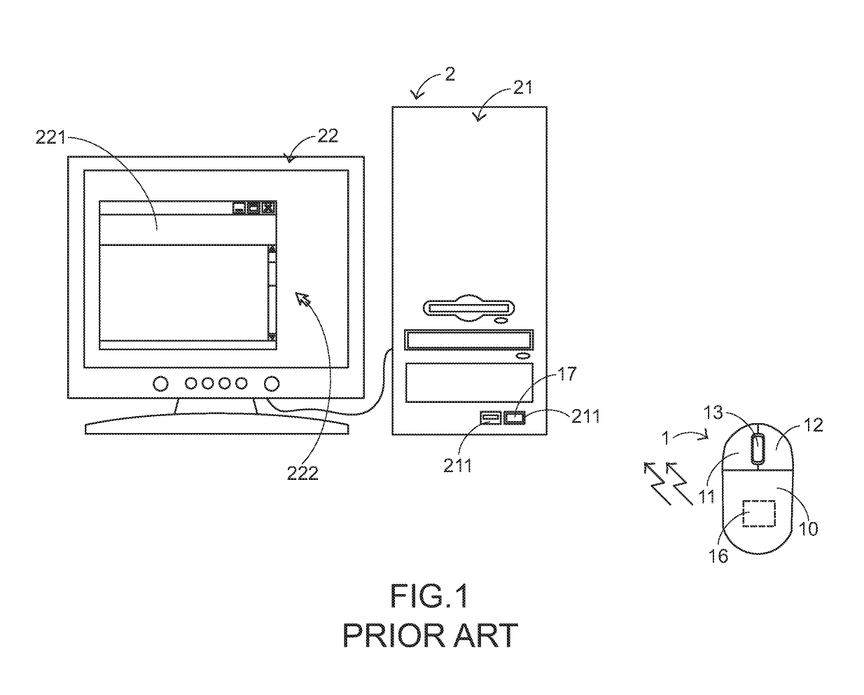

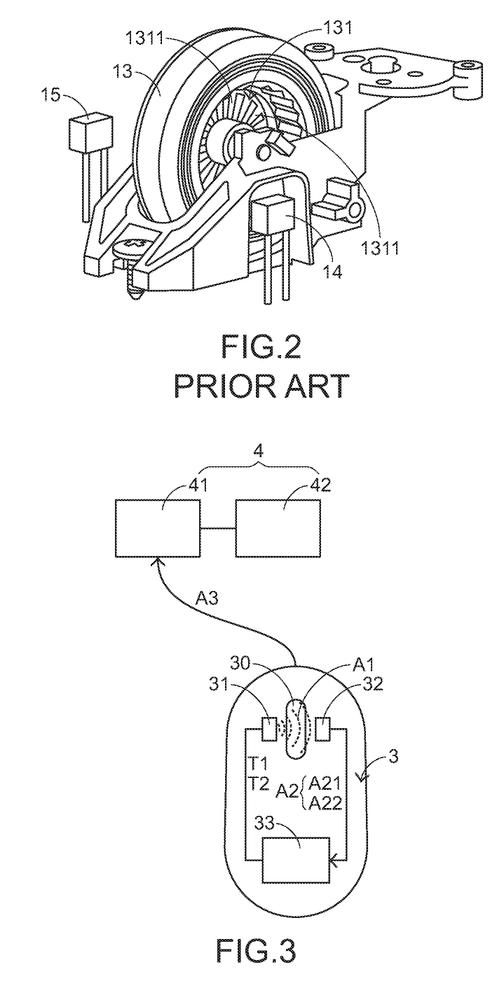

FIG. 3 schematically illustrates the communication between a wheel mouse and a computer system according to an embodiment of the present invention. In FIG. 3, a wheel mouse 3 and a computer host 4 are shown. The computer system 4 comprises a computer host 41 and a display screen 42. The structures of the computer host 41 and the display screen 42 are similar to those of the conventional computer host 21 and the conventional display screen 22 shown in FIG. 1, and are not redundantly described herein. The wheel mouse 3 is in communication with the computer host 41 of the computer system 4. Moreover, the wheel mouse 3 comprises a scroll wheel 30, a light emitter 31, a light receiver 32, and a controlling unit 33. The scroll wheel 30 is triggered when the scroll wheel 30 is rotated by the user. The light emitter 31 is located at a first side of the scroll wheel 30 for generating an optical signal A1. The optical signal A1 is projected to the scroll wheel 30. The light receiver 32 is located at a second side of the scroll wheel 30 for receiving the optical signal A1 from the light emitter 31. According to the optical signal A1, the light receiver 32 generates an output signal A2 to the controlling unit 33.

The controlling unit 33 is in communication with the light emitter 31 and the light receiver 32. The controlling unit 33 has two functions. Firstly, the controlling unit 33 is used for controlling the illumination cycle of generating the optical signal A1. Secondly, the controlling unit 33 is used for receiving the output signal A2 from the light receiver 32. According to the change of the output signal A2, the controlling unit 33 will judge whether the scroll wheel 30 is triggered. In this embodiment, the light emitter 31 is an infrared light emitter, and the optical signal A1 is an infrared optical signal. In addition, the light receiver 32 is an infrared light receiver, and the output signal A2 is a logic level signal. In an embodiment, the controlling unit 33 is a microprocessor.

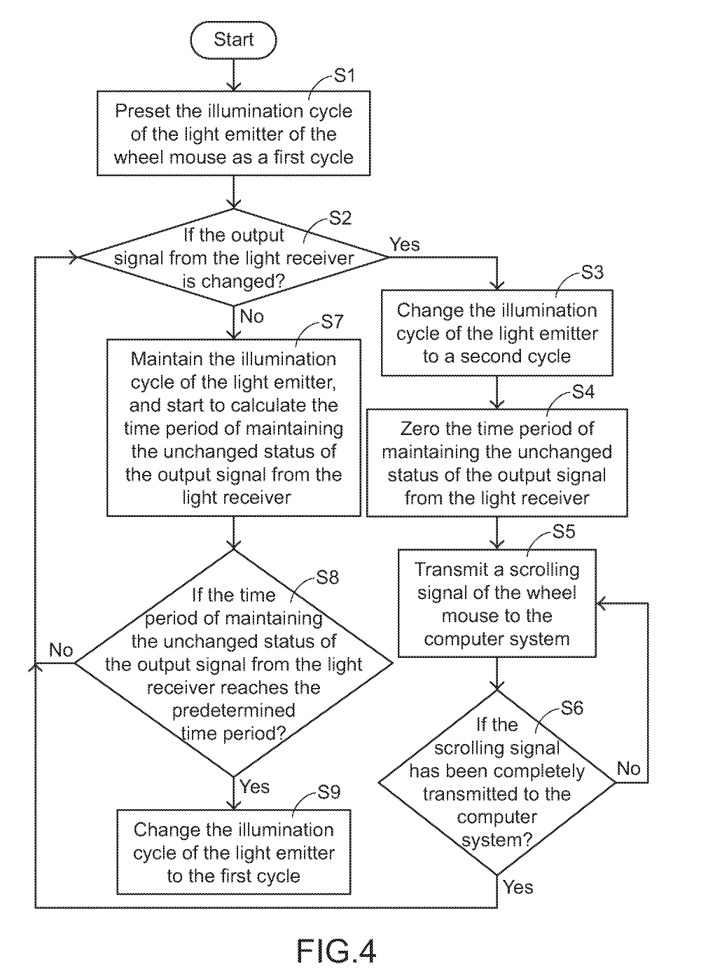

Hereinafter, a power-saving method for a wheel mouse according to an embodiment of the present invention will be illustrated with reference to FIG. 4. FIG. 4 is a flowchart illustrating a power-saving method for a wheel mouse according to an embodiment of the present invention. The power-saving method comprises the following steps. In the step S1, an illumination cycle of the light emitter 31 of the wheel mouse 3 is preset as a first cycle T1. The step S2 is performed to judge whether the output signal A2 from the light receiver 32 is changed. In the step S3, the illumination cycle of the light emitter 31 is changed to a second cycle T2. In the step S4, the time period of maintaining the unchanged status of the output signal A2 from the light receiver 32 is zeroed. In the step S5, a scrolling signal A3 of the wheel mouse 3 is transmitted to a computer system 4. The step S6 is performed to judge whether the scrolling signal A3 has been completely transmitted to the computer system 4. In the step S7, the illumination cycle of the light emitter 31 is maintained, and the time period of maintaining the unchanged status of the output signal A2 from the light receiver 32 is started to be calculated. The step S8 is performed to judge whether the time period of maintaining the unchanged status of the output signal A2 from the light receiver 32 reaches a predetermined time period Tp. In the step S9, the illumination cycle of the light emitter 31 is changed to the first cycle T1.

In this embodiment, the second cycle T2 is shorter than the first cycle T1. For example, the first cycle T1 is 10 milliseconds, the second cycle T2 is 500 microseconds, and the predetermined time period Tp is 2 seconds.

If the controlling unit 33 judges that the output signal A2 from the light receiver 32 is changed in the step S2, the step S3 is performed. Whereas, if the controlling unit 33 judges that the output signal A2 from the light receiver 32 is not changed in the step S2, the step S7 is performed. If the controlling unit 33 judges that the scrolling signal A3 has been completely transmitted to the computer system 4 in the step S6, the step S2 is performed again. Whereas, if the controlling unit 33 judges that the scrolling signal A3 has been not completely transmitted to the computer system 4 in the step S6, the step S5 is performed again. If the controlling unit 33 judges that the time period of maintaining the unchanged status of the output signal A2 from the light receiver 32 reaches the predetermined time period Tp in the step S8, the step S9 is performed. Whereas, if the controlling unit 33 judges that the time period of maintaining the unchanged status of the output signal A2 from the light receiver 32 does not reach the predetermined time period Tp in the step S8, the step S2 is performed again. After the step S9 is performed, the step S2 is performed again, so that the power-saving method for the wheel mouse is repeatedly done.

It is noted that the first cycle T1, the second cycle T2 and the predetermined time period Tp are previously set during the process of fabricating the wheel mouse 3. Moreover, after the wheel mouse 3 is enabled, according to these settings, the illumination cycle of the light emitter 31 is preset as the first cycle T1 by the controlling unit 33. In a case that the illumination cycle of the light emitter 31 is equal to the first cycle T1, the light emitter 31 generates the optical signal A1 once during each first cycle T1. On the other hand, the output signal A2 is continuously transmitted from the light receiver 32 to the controlling unit 33 in order to prevent from losing the optical signal A1.

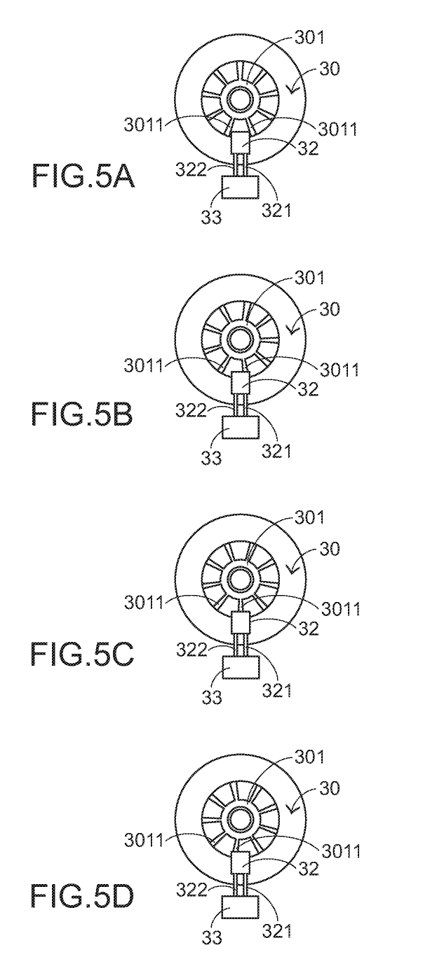

Hereinafter, some conditions of generating the output signal A2 by the light receiver 32 in response to the rotation of the scroll wheel 30 will be illustrated with reference to FIGS. 5A-5D. FIGS. 5A-5D schematically illustrate some conditions of generating the output signal by the light receiver of the wheel mouse of the present invention in response to the rotation of the scroll wheel. In FIG. 5A, the scroll wheel 30, the light receiver 32 and the controlling unit 33 are shown. The scroll wheel 30 has a grating structure 301. The grating structure 301 is disposed within the scroll wheel 30. The grating structure 301 comprises plural elongated elements 3011. In response to the rotation of the scroll wheel 30, each of the elongated elements 3011 is correspondingly moved. At the moment when one of the elongated elements 3011 is moved to a region between the light receiver 32 and the light emitter 31 (not shown), the optical signal A1 (not shown) from the light emitter 31 is blocked by the elongated element 3011. Under this circumstance, the optical signal A1 fails to be received by the light receiver 32.

The light receiver 32 has a first pin 321 and a second pin 322. The first pin 321 and the second pin 322 are in communication with the controlling unit 33. According to the relationship between the position of a specified elongated element 3011 and the light receiver 32, the first pin 321 and the second pin 322 issue a first logic level signal A21 and a second logic level signal A22, respectively. The output signal A2 is collaboratively defined by the first logic level signal A21 and the second logic level signal A22.

As shown in FIG. 5A, the elongated element 3011 is moved to a position near the light receiver 32 and has not been transferred through the light receiver 32. Meanwhile, since the optical signal A1 from the light emitter 31 is not blocked by the elongated element 3011, the optical signal A1 can be received by the light receiver 32. Under this circumstance, the first logic level signal A21 generated by the first pin 321 is a high logic level signal with the logic value “1”, and the second logic level signal A22 generated by the second pin 322 is also a high logic level signal with the logic value “1”. In other words, the output signal A2 received by the controlling unit 33 is (1, 1).

Next, as shown in FIG. 5B, the scroll wheel 30 is rotated, and thus the elongated element 3011 is correspondingly moved to a position corresponding to a front end of the light receiver 32 (i.e. at the position corresponding to the first pin 321). Meanwhile, the optical signal A1 from the light emitter 31 is partially blocked by the elongated element 3011. Consequently, the optical signal A1 fails to be received by the front end of the light receiver 32, but the optical signal A1 can still be received by a rear end of the light receiver 32 (i.e. at the position corresponding to the second pin 322). Under this circumstance, the first logic level signal A21 generated by the first pin 321 is a low logic level signal with the logic value “0”, and the second logic level signal A22 generated by the second pin 322 is still the high logic level signal with the logic value “1”. In other words, the output signal A2 received by the controlling unit 33 is (0, 1).

Next, as shown in FIG. 5C, the scroll wheel 30 is continuously rotated, and thus the elongated element 3011 is correspondingly moved to a position corresponding to a middle region of the light receiver 32. Meanwhile, the optical signal A1 from the light emitter 31 is blocked by the elongated element 3011, and thus the optical signal A1 fails to be received by the light receiver 32. Under this circumstance, the first logic level signal A21 generated by the first pin 321 is a low logic level signal with the logic value “0”, and the second logic level signal A22 generated by the second pin 322 is also a low logic level signal with the logic value “0”. In other words, the output signal A2 received by the controlling unit 33 is (0,0).

Next, as shown in FIG. 5D, the scroll wheel 30 is continuously rotated, and thus the elongated element 3011 is correspondingly moved to a position corresponding to a rear end of the light receiver 32. Meanwhile, the optical signal A1 from the light emitter 31 is partially blocked by the elongated element 3011. Consequently, the optical signal A1 can be received by the front end of the light receiver 32, but the optical signal A1 fails to be received by the rear end of the light receiver 32. Under this circumstance, the first logic level signal A21 generated by the first pin 321 is a high logic level signal with the logic value “1”, and the second logic level signal A22 generated by the second pin 322 is a low logic level signal with the logic value “0”. In other words, the output signal A2 received by the controlling unit 33 is (1,0).

As the scroll wheel 30 is continuously rotated, the elongated element 3011 is correspondingly moved to a position distant from the light receiver 32, and a next elongated element 3011 is correspondingly moved to a position near the light receiver 32. Meanwhile, the relationship between the position of the elongated element 3011 and the light receiver 32 is similar to that as shown in FIG. 5A. Meanwhile, since the optical signal A1 from the light emitter 31 is not blocked by the elongated element 3011, the optical signal A1 can be received by the light receiver 32. Under this circumstance, the first logic level signal A21 generated by the first pin 321 is a high logic level signal with the logic value “1”, and the second logic level signal A22 generated by the second pin 322 is also a high logic level signal with the logic value “1”. In other words, the output signal A2 received by the controlling unit 33 is (1, 1).

A complete operating sequence as shown in FIGS. 5A-5D of transferring a specified elongated element 3011 through the region between the light emitter 31 and the light receiver 32 may be defined as a rotating graduation of the scroll wheel 30. Moreover, the step S2 of judging whether the output signal A2 from the light receiver 32 is changed is performed by determining whether the status as shown in each of FIGS. 5A-5D is switched to another status (i.e. by determining whether the scroll wheel 30 is triggered).

Hereinafter, the operations of the power-saving method for the wheel mouse according to the present invention will be illustrated with reference to FIGS. 3 and 4 again. After the wheel mouse 3 is electrically powered on and the wheel mouse 3 is enabled, the controlling unit 33 is enabled to preset the illumination cycle of the light emitter 31 as a first cycle T1 (i.e. the step S1). In a case that the wheel mouse 3 is in an idle status or in a case that the wheel mouse 3 is operated by the user but the scroll wheel 30 is not triggered, the illumination cycle of the light emitter 31 is maintained at the first cycle T1. Then, the controlling unit 33 will judge whether the output signal A2 from the light receiver 32 is changed (i.e. the step S2). That is, by judging whether the status of the output signal A2 is changed, the controlling unit 33 may further judge whether the scroll wheel 30 is triggered or not. If the controlling unit 33 judges that the output signal A2 from the light receiver 32 is not changed, the illumination cycle of the light emitter 31 is maintained at the first cycle T1 by the controlling unit 33 and the time period of maintaining the unchanged status of the output signal A2 from the light receiver 32 is started to be calculated (i.e. the step S7). That is, the time period of maintaining the idle status of the scroll wheel 30 is calculated. After the step S7 is performed, the controlling unit 33 judges whether the time period of maintaining the unchanged status of the output signal A2 from the light receiver 32 reaches a predetermined time period Tp (i.e. the step S8). If the controlling unit 33 judges that the time period of maintaining the unchanged status of the output signal A2 from the light receiver 32 does not reach the predetermined time period Tp (e.g. 2 seconds), the step S2 is performed again by the controlling unit 33. The time interval between the step S2 at the first time and this step S2 at the second time is only equal to the duration of the first cycle T1 (i.e. 10 milliseconds).

On the other hand, if the controlling unit 33 judges that the status of the output signal A2 from the light receiver 32 is changed in the step S2 (i.e. the output signal A2 is switched from an unchanged status to a changed status), it means that the scroll wheel 30 is rotated by the user and the scroll wheel 30 is triggered. Under this circumstance, the illumination cycle of the light emitter 31 is changed from the first cycle T1 to a second cycle T2 by the controlling unit 33 (i.e. the step S3). In a case that the illumination cycle of the light emitter 31 is equal to the second cycle T2, the light emitter 31 generates the optical signal A1 once during each second cycle T2. Next, the time period of maintaining the unchanged status of the output signal A2 from the light receiver 32 is zeroed by the controlling unit 33 (i.e. the step S4). The change of the output signal A2 indicates that the scroll wheel 30 is triggered. Under this circumstance, the scrolling signal A3 of the wheel mouse 3 is transmitted from the controlling unit 33 to the computer host 41 of the computer system 4 (i.e. the step S5). In addition, the controlling unit 33 judges whether the scrolling signal A3 has been completely transmitted to the computer system 4 (i.e. the step S6). Consequently, the computer host 41 executes a corresponding command according to the scrolling signal A3. If the controlling unit 33 judges that the scrolling signal A3 has been completely transmitted to the computer system 4 in the step S6, the step S2 is performed by the controlling unit 33 again. Whereas, if the controlling unit 33 judges that the scrolling signal A3 has been not completely transmitted to the computer system 4 in the step S6, the step S5 is performed by the controlling unit 33 again.

After the scrolling signal A3 has been completely transmitted to the computer system 4, the controlling unit 33 performs the step S2 at the third time. When the user stops poking the scroll wheel 30 and the rotation of the scroll wheel 30 is stopped, the controlling unit 30 may judge that the output signal A2 from the light receiver 32 is no longer changed. Meanwhile, the illumination cycle of the light emitter 31 is maintained at the second cycle T2 by the controlling unit 33, and the time period of maintaining the unchanged status of the output signal A2 from the light receiver 32 is started to be calculated (i.e. the step S7). Then, the controlling unit 33 judges whether the time period of maintaining the unchanged status of the output signal A2 from the light receiver 32 reaches the predetermined time period Tp (i.e. the step S8). If the controlling unit 33 judges that the time period of maintaining the unchanged status of the output signal A2 from the light receiver 32 does not reach the predetermined time period Tp, the step S2 is performed by the controlling unit 33 again. Then, the scroll wheel 30 is not triggered by the user. Consequently, the output signal A2 from the light receiver 32 is maintained at the unchanged status, and the steps S2, S7 and S8 are repeatedly done by the controlling unit 33 until the controlling unit 33 judges that the time period of maintaining the unchanged status of the output signal A2 from the light receiver 32 reaches the predetermined time period Tp. Meanwhile, the illumination cycle of the light emitter 31 is changed to the first cycle T1 (i.e. the step S9). In a case that the illumination cycle of the light emitter 31 is equal to the first cycle T1, the light emitter 31 generates the optical signal A1 once during each first cycle T1. Then, the controlling unit 33 performs the step S2 again and waits for the triggering action of the scroll wheel 30. In such way, the power-saving method can be repeatedly executed.

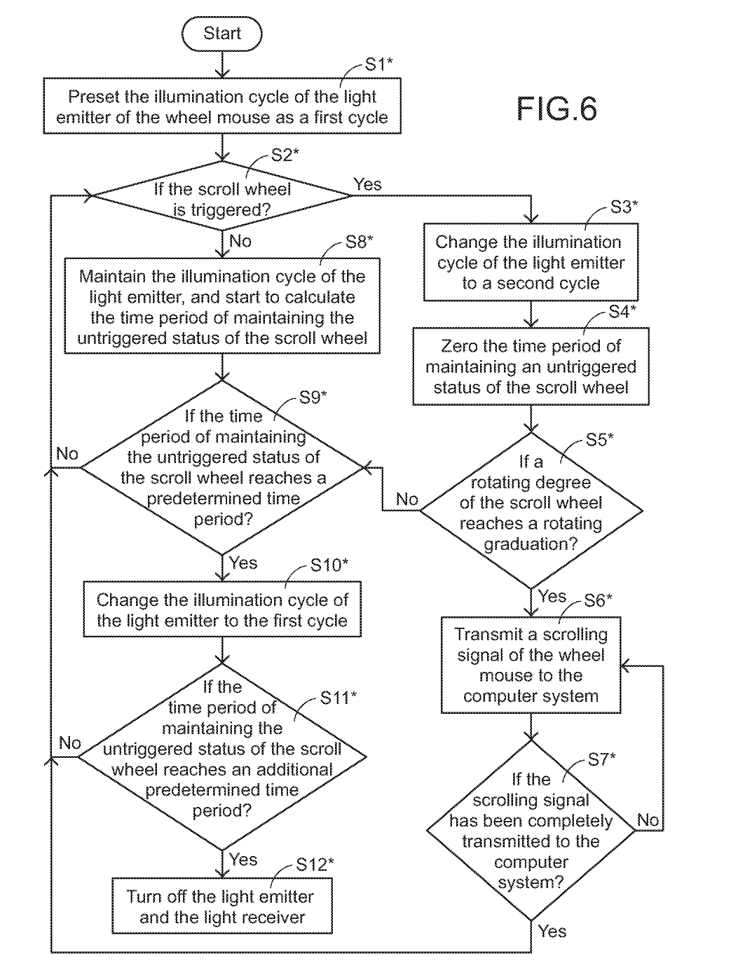

The present invention further provides a power-saving method for a wheel mouse according to another embodiment of the present invention. FIG. 6 is a flowchart illustrating a power-saving method for a wheel mouse according to another embodiment of the present invention. The power-saving method comprises the following steps. In the step S1*, an illumination cycle of the light emitter 31 of the wheel mouse 3 is preset as a first cycle T1. The step S2* is performed to judge whether the scroll wheel 30 is triggered. In the step S3*, the illumination cycle of the light emitter 31 is changed to a second cycle T2. In the step S4*, the time period of maintaining an untriggered status of the scroll wheel 30 is zeroed. The step S5* is performed to judge whether the rotating degree of the scroll wheel 30 reaches the rotating graduation. In the step S6*, a scrolling signal A3 of the wheel mouse 3 is transmitted to a computer system 4. The step S7* is performed to judge whether the scrolling signal A3 has been completely transmitted to the computer system 4. In the step S8*, the illumination cycle of the light emitter 31 is maintained and the time period of maintaining the untriggered status of the scroll wheel 30 is started to be calculated. The step S9* is performed to judge whether the time period of maintaining the untriggered status of the scroll wheel 30 reaches a predetermined time period Tp. In the step S10*, the illumination cycle of the light emitter 31 is changed to the first cycle T1. The step S11* is performed to judge whether the time period of maintaining the untriggered status of the scroll wheel 30 reaches an additional predetermined time period Tp*. In the step S12*, the light emitter 31 and the light receiver 32 are turned off.

If the controlling unit 33 judges that the scroll wheel 30 is triggered in the step S2*, the step S3* is performed. Whereas, if the controlling unit 33 judges that the scroll wheel 30 is not triggered in the step S2*, the step S8* is performed. If the controlling unit 33 judges that the rotating degree of the scroll wheel 30 reaches the rotating graduation in the step S5*, the step S6* is performed. Whereas, if the controlling unit 33 judges that the rotating degree of the scroll wheel 30 does not reach the rotating graduation in the step S5*, the step S9* is performed. If the controlling unit 33 judges that the scrolling signal A3 has been completely transmitted to the computer system 4 in the step S7*, the step S2* is performed again. Whereas, if the controlling unit 33 judges that the scrolling signal A3 has been not completely transmitted to the computer system 4 in the step S7*, the step S6* is performed again. If the controlling unit 33 judges that the time period of maintaining the untriggered status of the scroll wheel 30 reaches the predetermined time period Tp in the step S9*, the step S10* is performed. Whereas, if the controlling unit 33 judges that the time period of maintaining the untriggered status of the scroll wheel 30 does not reach the predetermined time period Tp in the step S9*, the step S2* is performed again. If the controlling unit 33 judges that the time period of maintaining the untriggered status of the scroll wheel 30 reaches the additional predetermined time period Tp* in the step S11*, the step S12* is performed. Whereas, if the controlling unit 33 judges that the time period of maintaining the untriggered status of the scroll wheel 30 does not reach the additional predetermined time period Tp* in the step S11*, the step S2* is performed again. After the step S12* is performed by the controlling unit 33, it means that the wheel mouse 3 has entered a sleep mode. Afterwards, if the wheel mouse 3 is triggered by the triggering action of rotating the scroll wheel, clicking the button or moving the mouse, the power-saving method is activated again and the step S1* is started.

Except for the following three items, the power-saving method of this embodiment is substantially identical to the power-saving method of the above embodiment. Firstly, in the power-saving method of this embodiment, the additional predetermined time period Tp* is further provided, wherein the additional predetermined time period Tp* is longer than the predetermined time period Tp. For example, the additional predetermined time period Tp* is 30 seconds. Secondly, the power-saving method of this embodiment further comprises a signal transmission judgment step (i.e. the step S5*). In the step S5*, the way of judging whether the rotating degree of the scroll wheel 30 reaches the rotating graduation may be performed according to the contents as shown in FIGS. 5A-5D. If the rotating degree of the scroll wheel 30 does not reach the rotating graduation, it means that the scroll wheel 30 is inadvertently touched. That is, the scrolling signal A3 corresponding to the rotating degree lower than the rotating graduation is not transmitted to the computer system 4. Consequently, the power-saving efficacy may be further enhanced. Thirdly, the power-saving method of this embodiment further comprises a sleep mode judgment step (i.e. the step S11*). After the wheel mouse 3 enters the sleep mode, the power-saving efficacy of the wheel mouse 3 is further enhanced.

Hereinafter, the operations of the power-saving method for the wheel mouse according to the present invention will be illustrated with reference to FIGS. 3 and 6 again. Firstly, the condition that the scroll wheel 30 of the wheel mouse 3 is not triggered will be discussed as follows. After the wheel mouse 3 is electrically powered on and enabled, the controlling unit 33 is enabled to preset the illumination cycle of the light emitter 31 as a first cycle T1 (i.e. the step S1*). In a case that the wheel mouse 3 is in an idle status or in a case that the wheel mouse 3 is operated by the user but the scroll wheel 30 is not triggered, the illumination cycle of the light emitter 31 is maintained at the first cycle T1. Then, the controlling unit 33 will judge whether the scroll wheel 30 is triggered (i.e. the step S2*). If the controlling unit 33 judges that the scroll wheel 30 is not triggered, the illumination cycle of the light emitter 31 is maintained at the first cycle T1 by the controlling unit 33 and the time period of maintaining the untriggered status of the scroll wheel 30 is started to be calculated (i.e. the step S8*). That is, the time period of maintaining the scroll wheel 30 in the idle status is calculated.

After the step S8* is performed, the controlling unit 33 judges whether the time period of maintaining the untriggered status of the scroll wheel 30 reaches a predetermined time period Tp (i.e. the step S9*). If the controlling unit 33 judges that the time period of maintaining the untriggered status of the scroll wheel 30 does not reach the predetermined time period Tp (e.g. 2 seconds), the step S2 will be performed again by the controlling unit 33. Whereas, if the controlling unit 33 judges that the time period of maintaining the untriggered status of the scroll wheel 30 reaches the predetermined time period Tp, the step S10* is performed by the controlling unit 33. Meanwhile, since the illumination cycle of the light emitter 31 is originally the first cycle T1, the step S11* is continuously performed by the controlling unit 33. If the controlling unit 33 judges that the time period of maintaining the untriggered status of the scroll wheel 30 does not reach the additional predetermined time period Tp* (e.g. 30 seconds), the step S2* is performed again. The steps S2*, S8*, S9*, S10* and S11* are repeatedly done. Until the time period of maintaining the untriggered status of the scroll wheel 30 reaches the additional predetermined time period Tp*, the light emitter 31 and the light receiver 32 are turned off (i.e. the step S12*).

Next, the condition that the scroll wheel 30 of the wheel mouse 3 is triggered will be discussed as follows. In a case that the wheel mouse 3 in the sleep mode is triggered by the user, the wheel mouse 3 is switched from the sleep mode to a working mode. In the working mode, the light emitter 31 and the light receiver 32 are turned on, and the step S1* is performed by the controlling unit 33. After the step S1* is performed, the step S2* is performed by the controlling unit 33. If the controlling unit 33 judges that the scroll wheel 30 is triggered, the illumination cycle of the light emitter 31 is changed from the first cycle T1 to the second cycle T2 by the controlling unit 33 (i.e. the step S3*). Then, the time period of maintaining the untriggered status of the scroll wheel 30 is zeroed by the controlling unit 33 (i.e. the step S4*). In addition, the controlling unit 33 judges whether the rotating degree of the scroll wheel 30 reaches the rotating graduation (i.e. the step S5*). If the controlling unit 33 judges that the rotating degree of the scroll wheel 30 reaches the rotating graduation, the steps S6*, S7*, S2*, S8* and S9* as mentioned above are performed and the steps S2*, S8* and S9* are repeatedly done. Consequently, the illumination cycle of the light emitter 31 is changed to the first cycle T1 (i.e. the S10*). The operations of these steps are similar to those mentioned above, and are not redundantly described herein. The subsequent steps S11* and S12* are similar to those mentioned above, and are not redundantly described herein.

In the step S5*, if the controlling unit 33 judges that the rotating degree of the scroll wheel 30 does not reach the rotating graduation, the controlling unit 33 will judge whether the time period of maintaining the untriggered status of the scroll wheel 30 reaches the predetermined time period Tp (i.e. the step S9*). Then, similar to the above embodiment, the steps S2*, S8* and S9* are repeatedly done. Consequently, the illumination cycle of the light emitter 31 is changed to the first cycle T1 (i.e. the S10*). The subsequent steps S11* and S12* are similar to those mentioned above, and are not redundantly described herein.

From the above embodiments, the power-saving method of the present invention is used to control the illumination cycle of the light emitter by judging whether the scroll wheel is triggered or judging whether the output signal from the light receiver is changed. In a case that the illumination cycle of the light emitter is the shorter second cycle, the light emitter can quickly generate the optical signal. Since it is not necessary to temporarily turn off the light emitter, the optical signal is not lost and the possibility of erroneously operating the wheel mouse is minimized or eliminated. Whereas, in a case that the illumination cycle of the light emitter is the longer first cycle, the controlling unit can reduce the power consumption in order to achieve the power-saving efficacy. Moreover, since the second embodiment of the power-saving method further comprises the signal transmission judgment step (i.e. the step S5*) and the sleep mode judgment step (i.e. the step S11*), the power-saving efficacy of the wheel mouse is further enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power-saving method for a wheel mouse, said wheel mouse comprising a scroll wheel, a light emitter and a light receiver, said scroll wheel being rotated to be triggered, said light emitter generating an optical signal, said optical signal passing through said scroll wheel being received by said light receiver, said light receiver outputting an output signal according to said optical signal, said power-saving method comprising steps of:
presetting an illumination cycle of said light emitter as a first cycle;
judging whether said output signal from said light receiver is changed, wherein if said output signal from said light receiver is judged to be in a changed status, said illumination cycle of said light emitter is changed to a second cycle, wherein said second cycle is shorter than said first cycle; and
if said output signal from said light receiver is switched from said changed status to an unchanged status, judging whether a time period of maintaining said unchanged status of said output signal from said light receiver reaches a predetermined time period, wherein if said time period of maintaining said unchanged status of said output signal from said light receiver reaches said predetermined time period, said illumination cycle of said light emitter is changed to said first cycle, wherein if said time period of maintaining said unchanged status of said output signal from said light receiver does not reach said predetermined time period, said step of judging whether said output signal from said light receiver is changed is performed again.

2. The power-saving method according to claim 1, wherein if said illumination cycle of said light emitter is equal to said first cycle and said output signal from said light receiver is judged to be in said unchanged status, said power-saving method further comprises a step of starting to calculate said time period of maintaining said unchanged status of said output signal from said light receiver.

3. The power-saving method according to claim 2, wherein after said illumination cycle of said light emitter is controlled to be said first cycle, said power-saving method further comprises a step of judging whether said time period of maintaining said unchanged status of said output signal from said light receiver reaches an additional predetermined time period, wherein if said time period of maintaining said unchanged status of said output signal from said light receiver reaches said additional predetermined time period, said light emitter and said light receiver are turned off, wherein if said time period of maintaining said unchanged status of said output signal from said light receiver does not reach said additional predetermined time period, said step of judging whether said output signal from said light receiver is changed is performed again.

4. The power-saving method according to claim 3, wherein said predetermined time period is shorter than said additional predetermined time period.

5. The power-saving method according to claim 3, wherein if said time period of maintaining said unchanged status of said output signal from said light receiver does not reach said additional predetermined time period and if said output signal from said light receiver is judged to be in said unchanged status, said power-saving method further comprises a step of continuing to calculate said time period of maintaining said unchanged status of said output signal from said light receiver, wherein if said time period of maintaining said unchanged status of said output signal from said light receiver does not reach said additional predetermined time period and if said output signal from said light receiver is judged to be switched from said unchanged status to said changed status, said power-saving method further comprises steps of changing said illumination cycle of said light emitter to said second cycle and zeroing said time period of maintaining said unchanged status of said output signal from said light receiver.

6. The power-saving method according to claim 5, wherein after said time period of maintaining said unchanged status of said output signal from said light receiver is continued to be calculated, said power-saving method further comprises a step of judging again whether said time period of maintaining said unchanged status of said output signal from said light receiver reaches said additional predetermined time period.

7. The power-saving method according to claim 1, wherein if said time period of maintaining said unchanged status of said output signal from said light receiver does not reach said predetermined time period and if said output signal from said light receiver is judged to be in said unchanged status, said power-saving method further comprises a step of continuing to calculate said time period of maintaining said unchanged status of said output signal from said light receiver, wherein if said time period of maintaining said unchanged status of said output signal from said light receiver does not reach said predetermined time period and if said output signal from said light receiver is judged to be switched from said unchanged status to said changed status, said power-saving method further comprises steps of changing said illumination cycle of said light emitter to said second cycle and zeroing said time period of maintaining said unchanged status of said output signal from said light receiver.

8. The power-saving method according to claim 7, wherein after said time period of maintaining said unchanged status of said output signal from said light receiver is continued to be calculated, said power-saving method further comprises a step of judging again whether said time period of maintaining said unchanged status of said output signal from said light receiver reaches said predetermined time period.

9. The power-saving method according to claim 7, wherein after said time period of maintaining said unchanged status of said output signal from said light receiver is zeroed, if said output signal from said light receiver is judged to be switched from said unchanged status to said changed status, said power-saving method further comprises a step of judging again whether said time period of maintaining said unchanged status of said output signal from said light receiver reaches said predetermined time period.

10. The power-saving method according to claim 1, wherein after said illumination cycle of said light emitter is changed to said second cycle, said power-saving method further comprises steps of:
transmitting a scrolling signal of said wheel mouse to a computer system; and
judging whether said scrolling signal has been completely transmitted to said computer system, wherein if said scrolling signal has been not completely transmitted to said computer system, said scrolling signal is continuously transmitted to said computer system, wherein if said scrolling signal has been completely transmitted to said computer system, said step of judging whether said output signal from said light receiver is changed is performed again.

11. A power-saving method for a wheel mouse, said wheel mouse comprising a scroll wheel, a light emitter and a light receiver, said scroll wheel being rotated to be triggered, said light emitter generating an optical signal, said optical signal passing through said scroll wheel being received by said light receiver, said light receiver outputting an output signal according to said optical signal, said power-saving method comprising steps of:
presetting an illumination cycle of said light emitter as a first cycle;
judging whether said scroll wheel is triggered, wherein if said scroll wheel is judged to be in a triggered status, said illumination cycle of said light emitter is changed to a second cycle, wherein said second cycle is shorter than said first cycle; and
if said scroll wheel is switched from said triggered status to an untriggered status, judging whether a time period of maintaining said untriggered status of said scroll wheel reaches a predetermined time period, wherein if said time period of maintaining said untriggered status of said scroll wheel reaches said predetermined time period, said illumination cycle of said light emitter is changed to said first cycle, wherein if said time period of maintaining said untriggered status of said scroll wheel does not reach said predetermined time period, said step of judging whether said scroll wheel is triggered is performed again.

12. The power-saving method according to claim 11, wherein if said illumination cycle of said light emitter is equal to said first cycle and said scroll wheel is judged to be in said untriggered status, said power-saving method further comprises a step of starting to calculate said time period of maintaining said untriggered status of said scroll wheel.

13. The power-saving method according to claim 12, wherein after said illumination cycle of said light emitter is controlled to be said first cycle, said power-saving method further comprises a step of judging whether said time period of maintaining said untriggered status of said scroll wheel reaches an additional predetermined time period, wherein if said time period of maintaining said untriggered status of said scroll wheel reaches said additional predetermined time period, said light emitter and said light receiver are turned off, wherein if said time period of maintaining said untriggered status of said scroll wheel does not reach said additional predetermined time period, said step of judging whether said scroll wheel is triggered is performed again.

14. The power-saving method according to claim 13, wherein said predetermined time period is shorter than said additional predetermined time period.

15. The power-saving method according to claim 13, wherein if said time period of maintaining said untriggered status of said scroll wheel does not reach said additional predetermined time period and if said scroll wheel is judged to be in said untriggered status, said power-saving method further comprises a step of continuing to calculate said time period of maintaining said untriggered status of said scroll wheel, wherein if said time period of maintaining said untriggered status of said scroll wheel does not reach said additional predetermined time period and if said scroll wheel is judged to be switched from said untriggered status to said triggered status, said power-saving method further comprises steps of changing said illumination cycle of said light emitter to said second cycle and zeroing said time period of maintaining said untriggered status of said scroll wheel.

16. The power-saving method according to claim 15, wherein after said time period of maintaining said untriggered status of said scroll wheel is continued to be calculated, said power-saving method further comprises a step of judging again whether said time period of maintaining said untriggered status of said scroll wheel reaches said additional predetermined time period.

17. The power-saving method according to claim 11, wherein if said time period of maintaining said untriggered status of said scroll wheel does not reach said predetermined time period and if said scroll wheel is judged to be in said untriggered status, said power-saving method further comprises a step of continuing to calculate said time period of maintaining said untriggered status of said scroll wheel, wherein if said time period of maintaining said untriggered status of said scroll wheel does not reach said predetermined time period and if said scroll wheel is judged to be switched from said untriggered status to said triggered status, said power-saving method further comprises steps of changing said illumination cycle of said light emitter to said second cycle and zeroing said time period of maintaining said untriggered status of said scroll wheel.

18. The power-saving method according to claim 17, wherein after said time period of maintaining said untriggered status of said scroll wheel is continued to be calculated, said power-saving method further comprises a step of judging again whether said time period of maintaining said untriggered status of said scroll wheel reaches said predetermined time period.

19. The power-saving method according to claim 17, wherein after said time period of maintaining said untriggered status of said scroll wheel is zeroed, if said scroll wheel is judged to be switched from said untriggered status to said triggered status, said power-saving method further comprises a step of judging again whether said time period of maintaining said untriggered status of said scroll wheel reaches said predetermined time period.

20. The power-saving method according to claim 17, wherein after said time period of maintaining said untriggered status of said scroll wheel is zeroed, said power-saving method further comprises a step of judging whether a rotating degree of said scroll wheel reaches a rotating graduation, wherein if said rotating degree of said scroll wheel does not reach said rotating graduation, said power-saving method further comprises a step of judging whether said time period of maintaining said untriggered status of said scroll wheel reaches said predetermined time period.

21. The power-saving method according to claim 11, wherein after said illumination cycle of said light emitter is changed to said second cycle, said power-saving method further comprises steps of:
transmitting a scrolling signal of said wheel mouse to a computer system; and
judging whether said scrolling signal has been completely transmitted to said computer system, wherein if said scrolling signal has been not completely transmitted to said computer system, said scrolling signal is continuously transmitted to said computer system, wherein if said scrolling signal has been completely transmitted to said computer system, said step of judging whether said scroll wheel is triggered is performed again.
